(19) United States
(12) Patent Application Publication
(10) Pub. No.: US 2006/0023878 A1
(43) Pub. Date: Feb. 2, 2006

(54) Modular multipliers having segmentable structure and cryptography systems utilizing same

(76) Inventor: Hee-kwan Son, Gyeonggi-do (KR)

Correspondence Address: MYERS BIGEL SIBLEY & SAJOVEC, PO BOX 37428, RALEIGH, NC, 27627, US

(21) Appl. No.: 11/192,237

(22) Filed: Jul. 28, 2005

(30) Foreign Application Priority Data
Jul. 29, 2004 (KR) 2004-59739

(51) Int. Cl. H04L 9/28; H04L 9/00; H04K 1/00

(52) U.S. Cl. 380/28; 380/44

(57) ABSTRACT

A segmentable modular multiplier circuit includes a control circuit configured to produce a mode control signal and operation control signals in response to a control signal and a calculator circuit configured to perform modular multiply operations on first and second bit length operands in respective first and second modes responsive to the mode control signal and the operation control signals. The control circuit may include a host interface unit configured to produce an operation information signal in response to a control data signal received from a host and a controller configured to produce the mode control signal and the operation control signals in response to the operation information signal.

### CROSS-REFERENCE TO RELATED APPLICATION

This application claims the benefit of Korean Patent Application No. 10-2004-0059739, filed on Jul. 29, 2004, in the Korean Intellectual Property Office, the disclosure of which is incorporated herein in its entirety by reference.

### BACKGROUND OF THE INVENTION

The present invention relates to a cryptography systems and methods and, more particularly, to modular multipliers for executing public key cryptography algorithms.

In general, cryptography methods can be classified into cryptography methods using a secret key (or a symmetric key) and cryptography methods using a public key (or an asymmetric key). In cryptography methods using a secret key, two communication apparatuses typically encode and transmit data or decode received data using the same secret key. To communicate with a plurality of communication apparatuses through a cryptography method using a secret key, the communication apparatuses generally need to hold the same secret key. The communication apparatuses may have difficulties in managing the secret key and a safe communication channel for only the two communication apparatuses may be necessary.

In cryptography methods using a public key, a communication apparatus encodes and transmits data using a public key of the other party with which the communication apparatus wants to communicate, and decodes received data using its own secret key, which is non-public. Accordingly, a safe communication channel may not be required and a single public communication channel may be used. In cryptography methods using a public key, because each communication apparatus holds only its own secret key, key management can be simplified. Due to such advantages, public key cryptography algorithms have been adapted in many cryptography systems. Representative examples of public key cryptography algorithms include the RSA (Ron Rivest, Adi Shamir, and Len Adleman), DH (Diffie-Hellman) and ECC (Elliptic Curve Cryptosystem) algorithms. In these public key cryptography algorithms, a modular multiplication for modular exponentiation is used as a basic operation.

For example, for communication apparatuses A and B, plain text M and cipher text C generated by a public key cryptography algorithm can be expressed by Equation (1):
C=M^{e}^{_{B mod n}}_{B}
M=C^{d}^{_{B mod n}}_{B} (1)
In Equation (1), e_{B} and d_{B} are a public key and a secret key of the communication apparatus B, respectively, n_{B} is a modulus published by the communication apparatus B and mod represents a modulo operation. The e_{B} and n_{B} are published information and the d_{B} is non-public secret information which the communication apparatus B holds. Referring to Equation (1), if the communication apparatus A creates a cipher text C using the public key e_{B} and the modulus n_{B} of the communication apparatus B and transmits the cipher text C to the communication apparatus B, the communication apparatus B decodes the cipher text C using its own secret key d_{B} and the modulus n_{B}.

In a digital signature using a public key cryptography algorithm, the cipher text C and the decoded text M can be expressed by Equation (2):
C=M^{d}^{_{A mod n}}_{A}
M=C^{e}^{_{A mod}} _{A} (2)
In Equation (2), e_{A}, d_{A} and n_{A} are a public key, a secret key and a modulus of the communication apparatus A, respectively. Referring to Equation (2), in a digital signature, the secret key d_{A} is used for encoding and the public key e_{A} is used for decoding. In other words, the communication apparatus A creates the cipher text C using its own secret key d_{A} and transmits the cipher text C to the communication apparatus B, and the communication apparatus B decodes the cipher text C using the public key e_{A} and the modulus n_{A} of the communication apparatus A.

In a cryptography system using the RSA algorithm, to enhance operation performance, a Garner's algorithm in which CRT (Chinese Remainder Theorem) is applied to the RSA algorithm can be additionally used. Hereinafter, a digital signature procedure by the RSA algorithm using the Garner's algorithm is briefly described.

First, a digital signature value S encoded by the RSA algorithm can be expressed by Equation 3:
S=M^{d} mod n (3)
In Equation (3), M is a message on which a digital signature will be affixed and d and n are a secret key and a modulus of a communication apparatus for performing the digital signature, respectively. Here, n is public information and d is non-public information.

To obtain the digital signature value S, an encoding procedure by the Garner's algorithm can be expressed by Equation (4):
S=S_{q}+[(Sₚ−S_{q})(q⁻¹ mod p)mod p]_{q} (4)
In Equation (4), q⁻¹ mod p is a pre-calculated value and corresponds to a J value for making the calculation result of (q×J)mod p to 1. Also, Sₚ and S_{q} can be expressed by Equations 5:
Sₚ=(Mₚ)^{d}^{ₚ} mod p
S_{q}=(M_{q})^{d}^{_{q}} mod q
dₚ=d mod(p−1)
d_{q}=d mod(q−1) (5)

Referring to Equations (3), (4) and (5), p and q are different prime numbers, a product of p and q is equal to n, and the lengths of p and q are a half of that of the n, respectively. p and q are secret information held by a communication apparatus for performing decoding in a cryptography system or a communication apparatus for performing a digital signature in a digital signature system. dₚ and d_{q} are pre-calculated values and the lengths of Mₚ, M_{q}, dₚ and d_{q} are a half of that of the n, respectively.

During digital signature, typically a conventional modular multiplier sequentially performs an operation for obtaining Sₚ (operation 1), an operation for obtaining S_{q} (operation 2), and an operation for obtaining S (operation 3). The operations 1 and 2 typically occupy the greater portion of the entire operation performed by the modular multiplier and a time needed for the operation 3 (reconstruction) is relatively small.

A side-channel attack method that attacks such a cryptography or digital signature system is DFA (Differential Fault Analysis). The DFA generates an error in any one of the operations for obtaining the Sₚ and the operation for obtaining the S_{q}, Because the operation for obtaining the Sₚ and the operation for obtaining the S_{q} typically require a lot of time and the conventional modular multiplier performs the operations sequentially, it may be very easy for an attacker to generate an error in any one of the operations. For example, by sharply reducing a supply voltage of the cryptography system or by inserting a glitch into a clock signal, an error can be generated in the cryptography system. If one of the Sₚ and S_{q} includes an error, the attacker can obtain values of p and q as secret information from the Sₚ and S_{q}. However, if both the Sₚ and S_{q} include errors, the attacker may not be able to obtain values of p and q as secret information from the Sₚ and S_{q}, As described above, since the conventional cryptography system using the RSA algorithm to which CRT is applied is vulnerable to a side-channel attack such as DFA, system safety cannot be ensured. Accordingly, the conventional cryptography system may need to perform an additional operation for preventing DFA. However, such additional operation can cause performance deterioration of the cryptography system.

### SUMMARY OF THE INVENTION

Some embodiments of the present invention provide modular multipliers with a segmentable operation structure, which can enhance safety and performance of a cryptography system by allowing simultaneous and independent modular multiply operations. Further embodiments of the present invention provide cryptography systems including modular multipliers capable of segmented operation

In some embodiments of the present invention, a modular multiplier circuit includes a control circuit configured to produce a mode control signal and operation control signals in response to a control signal and a calculator circuit configured to perform modular multiply operations on first and second bit length operands in respective first and second modes responsive to the mode control signal and the operation control signals. The control circuit may include a host interface unit configured to produce an operation information signal in response to a control data signal received from a host and a controller configured to produce the mode control signal and the operation control signals in response to the operation information signal.

In further embodiments of the present invention, in the first mode, the calculator circuit is configurable to independently and simultaneously perform modular multiply operations on first operands and second operands to produce respective first operation results and second operation results. The first and second operands may have the same bit length. In the second mode, the calculator circuit may perform a modular multiply operation on third operands having a bit length greater than the first and second operands.

According to additional embodiments, the modular multiplier further includes a memory interface circuit configured to receive operands from a first memory and a second memory and to provide the received operands to the calculator circuit. The memory interface may include a first memory interface configured to be enabled or disabled in response to a first enable signal and a second memory interface configured to be enabled or disabled in response to the second enable signal. The control circuit may generate the first and second enable signals responsive to the control signal from the host.

In further embodiments of the present invention, the calculator circuit includes a segmentable Montgomery multiplier, a first signal pass circuit configured to transmit first input/output signals between the Montgomery multiplier and the first memory interface in response to the first selection control signals and the second selection control signals and a second signal pass circuit configured to transmit second input/output signals between the Montgomery multiplier and the second memory interface in response to the third selection control signals and the fourth selection control signals. In the first mode, the Montgomery multiplier may be configurable to independently and simultaneously perform a first Montgomery multiplication operation for a first operand and a second Montgomery multiplication operation for a second operand to produce respective first operation results and second operation results therefrom, wherein the first and second operation results are output via respective ones of a combination of the first signal pass circuit and the first memory interface and a combination of the second signal pass circuit and the second memory interface. In the first mode, the Montgomery multiplier may perform one of a first Montgomery multiplication operation for a first operand or a second Montgomery multiplication operation for a second operand and produces a first operation result or a second operation result therefrom, and wherein the first operation result or the second operations result is output via the first signal pass circuit and the first memory interface or the via the second signal pass circuit and the second memory interface. In the second mode, the second signal pass circuit and the second memory interface may operate while the first signal pass circuit and the first memory interface do not operate.

In additional embodiments of the present invention, a cryptography system includes first and second memories configured to store operands for modular multiplication operations. The system also includes a modular multiplier configured to read operands from the first and second memories and configurable to perform modular multiplication operations on first bit length operands from the first memory and/or the second memory in a first mode and to perform a modular multiplication operation on second bit length operands from the first and second memories in a second mode, and a host coupled to the modular multiplier and configured to provide a control signal thereto to selectively place the modular multiplier in the first and second modes. The system further includes a memory arbiter coupled to the first and second memories, the modular multiplier and the host and configured to control access to the first and second memories by the host and the modular multiplier responsive to access requests therefrom.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a modular multiplier according to some embodiments of the present invention;

FIG. 2 is a detailed block diagram of a Montgomery multiplier according to further embodiments of the present invention;

FIG. 3 is a block diagram of an accumulator according to some embodiments of the present invention;

FIG. 4 is a detailed block diagram of a first sub-accumulator according to some embodiments of the present invention;

FIG. 5 is a detailed block diagram of a compressor according to some embodiments of the present invention;

FIG. 6 is a detailed block diagram of a first lower value generator according to some embodiments of the present invention;

FIG. 7 is a detailed block diagram of a second sub-accumulator shown in FIG. 3; and

FIG. 8 is a schematic block diagram of a cryptography system including a modular multiplier according to some embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. Furthermore, “connected” or “coupled” as used herein may include wirelessly connected or coupled.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “includes,” “including” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present specification and will not be interpreted in an idealized or overly formal sense unless expressly so defined herein.

It will be understood that although the terms first and second are used herein to describe various elements, these elements should not be limited by these terms. These terms are only used to distinguish one element from another element. Thus, a first item could be termed a second item, and similarly, a second item may be termed a first item without departing from the teachings of the present invention. As used herein, the term “and/or” includes any and all combinations of one or more of the associated listed items. The symbol “/” may also used as a shorthand notation for “and/or”.

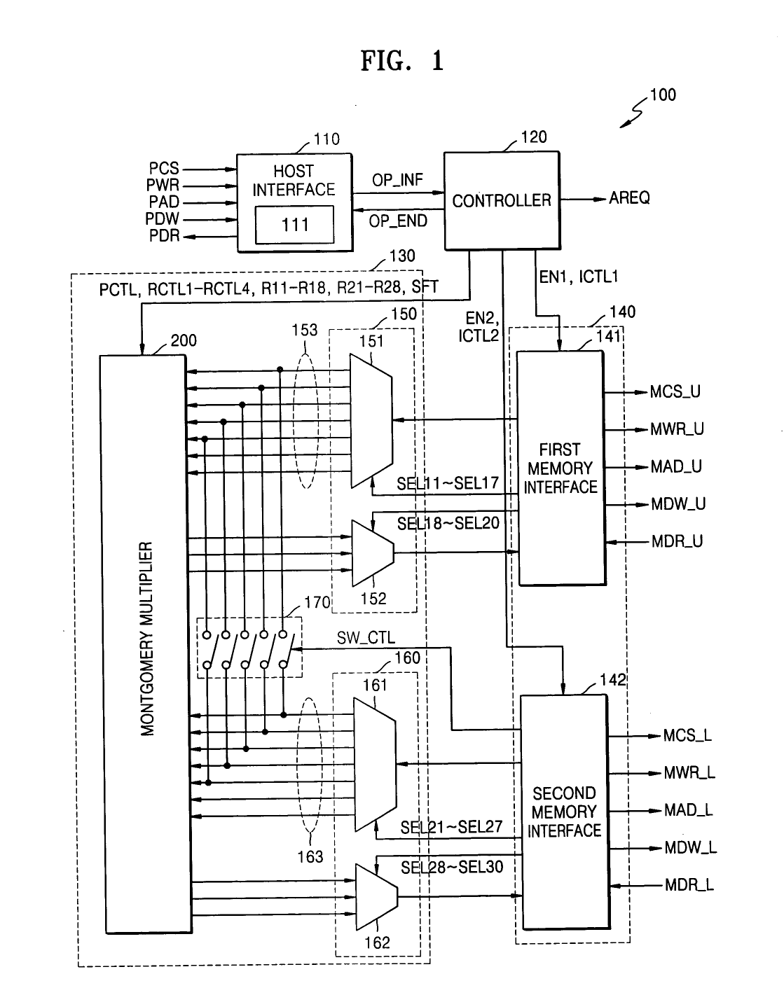

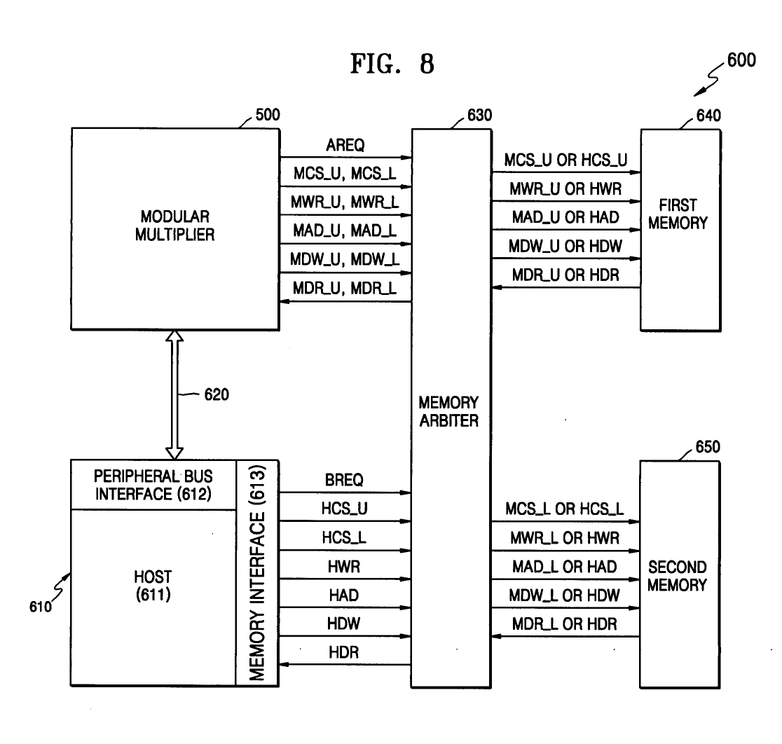

FIG. 1 is a block diagram of a modular multiplier 100 according to some embodiments of the present invention. Referring to FIG. 1, the modular multiplier 100 includes a host interface 110, a controller 120, a multiple calculator 130 and a memory interface 140. The host interface 110 includes a control register 111. The host interface 110 is enabled or disabled in response to a chip selection signal, and writes a control data signal PDW in the control register 111 or reads and outputs a state data signal PDR stored in the control register 111 in response to a write/read command PWR and an address signal PAD. The control data signal PDW, for example, includes operation information such as operation modes of the modular multiplier 100, the sizes of operands to be operated, and start timings of operations of the modular multiplier 100. The state data signal PDR indicates whether an operation of the modular multiplier 100 is terminated. Accordingly, a host (e.g., host 611 of FIG. 8) can determine whether an operation of the modular multiplier 100 is terminated, on the basis of the state data signal PDR.

If the control data signal PDW is written in the control register 111, the host interface 110 outputs an operation information signal OP_INF on the basis of the control data signal PDW. The operation information signal OP_INF represents the operation modes of the modular multiplier 100, the sizes of the operands to be operated and the start timings of the operations of the modular multiplier 100. The host interface 110 stores an operation end signal (OP_END) received from the controller 120 as the state data signal PDR in the control register 111.

The controller 120 decides an operation mode on the basis of the operation information signal OP_INF and controls operations of the multiple calculator 130 and the memory interface 140 according to the decided operation mode. The controller 120 enables a mode control signal PCTL if it is determined that the operation information signal OP_INF relates to a first operation mode and disables the mode control signal PCTL if it is determined that the operation information signal OP_INF relates to a second operation mode. In the first operation mode, the controller 120 enables both first and second enable signals EN1 and EN2 and enables one of the first and second enable signals EN1 and EN2, on the basis of the operation information signal OP_INF. In the first operation mode, if the controller 120 enables both the first and second enable signals EN1 and EN2, the controller 120 outputs recording control signals RCTL 1 through RCTL4, register control signals R11 through R18 and R21 through R28, a shifting signal SFT, a memory access request signal AREQ, and first and second control signals ICTL1 and ICTL2.

In the first operation mode, if the controller 120 enables one of the first and second enable signals EN1 and EN2, the controller 120 outputs the recording control signals RCTL2 and RCTL4, the register control signals R11 through R18 and R21 through R28, the shift signal SFT, the memory access request signal AREQ, and the first and second control signals ICTL1 and ICTL2. A memory arbiter (e.g., arbiter 630 of FIG. 8) assigns an access authority to the first and second memories (e.g., memories 640 and 650 of FIG. 8) to the modular multiplier 100, in response to the memory access request signal AREQ.

The multiple calculator 130 includes a first signal pass circuit 150, a second signal pass circuit 160, a switching circuit 170 and a Montgomery multiplier 200. The first signal pass circuit 150 includes a demultiplexer 151 and a multiplexer 152. The demultiplexer 151 successively outputs signals (that is, first half-sized operands for Montgomery multiplication) received from the memory interface 140 to the Montgomery multiplier 200 in response to selection control signals SEL11 through SEL17. The multiplexer 152 successively outputs signals (that is, the first half-sized operands) received from the Montgomery multiplier 200 to the memory interface 140 in response to selection control signals SEL18 through SEL20.

The second signal pass circuit 160 includes a demultiplexer 161 and a multiplexer 162. The demultiplexer 161 successively outputs signals (that is, second half-sized operands for Montgomery multiplication) received from the memory interface 140 to the Montgomery multiplier 200, in response to selection control signals SEL21 through SEL27. The multiplexer 162 successively outputs signals (that is, the second half-sized operands) received from the Montgomery multiplier 200 to the memory interface 140 in response to selection control signals SEL28 through SEL30. The switching circuit 170 connects or disconnects predetermined ones of output lines 153 of the demultiplexers 151 and 161 to/from each other, in response to a switching control signal SW_CTL.

The Montgomery multiplier 200 operates in one of the first and second operation modes in response to the mode control signal PCTL. In the first operation mode, the Montgomery multiplier 200 performs a first Montgomery multiply operation for the first operands and a second Montgomery multiply operation for the second operands, simultaneously and independently, and then outputs first operation result signals and second operation result signals, respectively. Alternately, in the first operation mode, the Montgomery multiplier 200 can perform one of the first and second Montgomery multiply operations and output first operation result signals or second operation result signals. As in the ECC algorithm, if multiplication for operands with lengths shorter than those of operations capable of being performed by the Montgomery multiplier 200 is required, the Montgomery multiplier 200 can perform only one of the first and second Montgomery multiply operations.

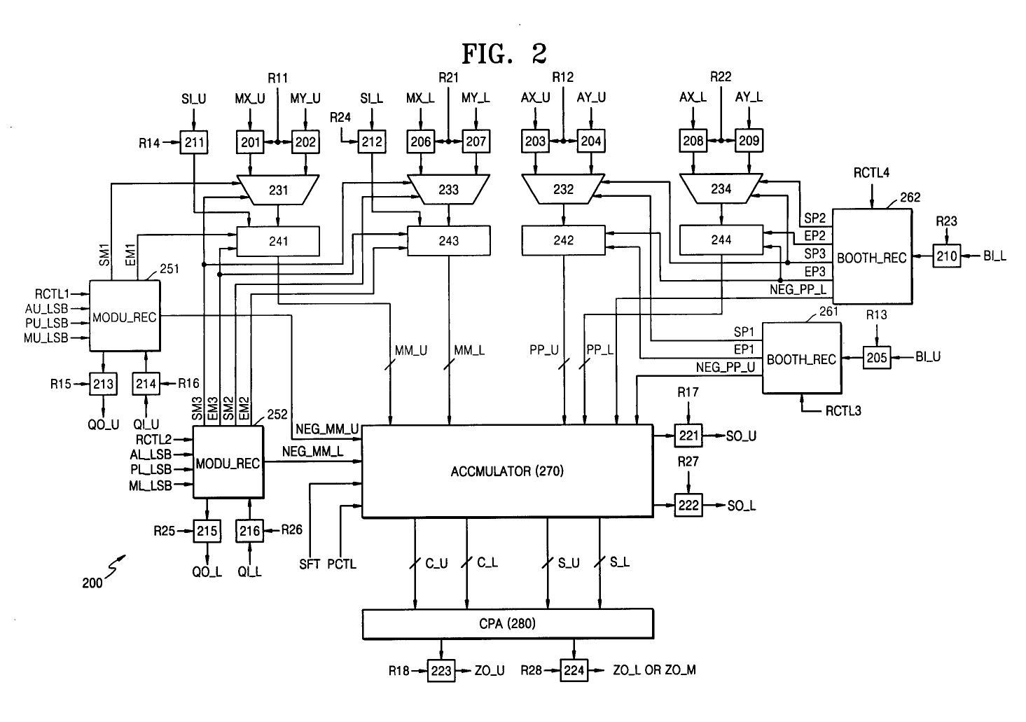

In the second operation mode, the Montgomery multiplier 200 performs a Montgomery multiply operation for full-sized operands including the first operands and the second operands and outputs corresponding operation result signals. Detailed descriptions for the configuration and operations of the Montgomery multiplier 200 will be given later with reference to FIG. 2.

The memory interface 140 includes a first memory interface 141 and a second memory interface 142. The memory interface 140 operates in one of a first mode and a second mode, in response to the first and second enable signals EN1 and EN2 and the first and second control signals ICTL1 and ICTL2. In the first mode, both of the first and second memory interfaces 141 and 142 are enabled or one of the first and second memory interfaces 141 and 142 is enabled. In the second mode, the second memory interface 141 is enabled and the first memory interface 141 is disabled.

The first memory interface 141 is enabled or disabled in response to the first enable signal EN1. If the first memory interface 141 is enabled, the first memory interface 141 generates a chip selection signal MCS_U, a read/write command MWR_U and an address signal MAD_U in response to the first control signal ICTL1 and outputs the generated signals to the first memory 640. Then, the first memory interface 141 receives the data signal MDR_U from the first memory 640 and outputs the data signal MDR_U to the Montgomery multiplier 200 through the demultiplexer 151 of the first signal pass circuit 150. The first memory interface 141 successively outputs the selection control signals SEL11 through SEL17. The data signal MDR_U includes the first operands.

The first memory interface 141 successively outputs the selection control signals SEL18 through SEL 20 in response to the first control signal ICTL1, and outputs the first operation result signals received from the Montgomery multiplier 200 through the multiplexer 152, as a write data signal MDW_U, with the read/write command MWR_U and the address signal MAD_U, to the first memory 640. As a result, the first operation result signals are stored in the first memory 640.

The second memory interface 142 is enabled or disabled in response to the second enable signal EN2. If the second memory interface 142 is enabled, the second memory interface 142 generates a chip selection signal MCS_L, a read/write command MWR_L and an address signal MAD_L in response to the second control signal ICTL2 and outputs the generated signals to the second memory 650. Then, the second memory interface 142 outputs a data signal MDR_L read from the second memory 650 to the Montgomery multiplier 200 through the demultiplexer 161 of the second signal pass circuit 160. The second memory interface 142 successively outputs the selection control signals SEL21 through SEL27. The data signal MDR_L includes the second operands.

The second memory interface 142 outputs the selection control signals SEL28 through SEL30 in response to the second control signal ICTL2, and outputs the second operation result signals received from the Montgomery multiplier 200 through the multiplexer 162, as a write data signal MDW_L, with the read/write command MWR_L and the address signal MAD_L, to the second memory 650. As a result, the second operation result signals are stored in the second memory 650.

In the second mode, the second memory interface 142 generates a read/write command MWR_L and an address signal MAD_L in response to the second control signal ICTL2 and outputs the generated signals to the first memory 640. The second memory interface 142 receives the data signal MDR_L from the first memory 640 and outputs the data signal MDR_L to the Montgomery multiplier 200 through the demultiplexer 161. The first memory interface 141 outputs the chip selection signal MCS_U and enables the first memory 640. The second memory interface 142 enables a switching control signal SW_CTL in response to the second control signal ICTL2. The switching circuit 170 is turned on in response to the switching control signal SW_CTL and connects predetermined ones of the output lines 163 of the demultiplexer 161 with predetermined ones of the output lines 153 of the demultiplexer 151. As a result, output signals of the demultiplexer 161 are provided to the internal components of the Montgomery multiplier 200 connected to the predetermined output lines of the demultiplexer 151.

FIG. 2 is a detailed block diagram of the Montgomery multiplier 200 shown in FIG. 1. Referring to FIG. 2, the Montgomery multiplier 200 includes a plurality of registers 201 through 216 and 221 through 224, multiplexers 231 through 234, first and second multiple modulus generators 241 and 243, first and second partial product generators 242 and 244, first and second modulus recorders 251 and 252, first and second booth recorders 261 and 262, an accumulator 270, and a carry propagation adder 280. The Montgomery multiplier 200 can be separated into two portions performing independent Montgomery multiply operations for the first and second half-sized operands. A portion for performing the Montgomery multiply operation for the first operands can include the registers 201 through 205, 211, 213, 214, 221 and 223, the multiplexers 231 and 232, the first multiple modulus generator 241, the first partial product generator 242, the first modulus recorder 251, the first booth recorder 261, the accumulator 270 and the carry propagation adder 280. A portion for performing the Montgomery multiply operation for the second operands can include the registers 206 through 210, 212, 215, 216, 222 and 224, the multiplexers 233 and 234, the second multiple modulus generator 243, the second partial product generator 244, the second modulus recorder 252, the second booth recorder 262, the accumulator 270 and the carry propagation adder 280.

The register 201 stores a first modulus MX_U received from one of the multiplexers 151 and 161 (see FIG. 1) in response to a register control signal R11, and outputs the stored first modulus MX_U. The register 202 stores a first modulus MY_U received from one of the multiplexers 151 and 161 in response to the register control signal R11, and outputs the stored first modulus MY_U. The first modulus MX_U is the first operand for the present operation and the first modulus MY_U is the first operand for the following operation.

The register 206 stores a second modulus MX_L received from the demultiplexer 161 in response to the register control signal R21 and outputs the stored second modulus MX_L. The register 207 stores the second modulus MY_L received from the demultiplexer 161 in response to the register control signal R21 and outputs the stored second modulus MY_L. The second modulus MX_L is the second operand for the present operation and the second modulus MY_L is the second operand for the following operation.

Each of the first and second moduli MX_U, MY_U, MX_L and MY_L has the length of C bits, wherein C is an integer. Here, multipliers supporting multiple precision such as the Montgomery multiplier 200 can process operands with lengths longer than those of basic operations of a corresponding hardware. For that, each of the operands is divided into basic length units (that is, chunk) of multiplier hardware. The length of C bits corresponds to a half of a basic length unit (chunk length) capable of being processed by the Montgomery multiplier 200.

The register 203 stores a first multiplicand AX_U received from one of the multiplexers 151 and 161 in response to the register control signal R12, and outputs the stored first multiplicand AX_U. The register 204 stores outputs of one of the multiplexers 151 and 161 in response to the register control signal R21 and outputs the stored first multiplicand AY_U. The first multiplicand AX_U is the first operand for the present operation and the first multiplicand AY_U is the first operand for the following operation.

The register 208 stores a second multiplicand AX_L received from the demultiplexer 161 in response to the register control signal R22, and outputs the stored second multiplicand AX_L. The register 209 stores the second multiplicand AY_L received form the demultiplexer 161 in response to the register control signal R22, and outputs the stored second multiplicand AY_L. The second multiplicand AX_L is the second operand for the present operation and the second multiplicand AY_L is the second operand for the following operation. Each of the first and second multiplicands AX_U, AY_U, AX_L and AY_L has the length of C bits.

The register 205 stores a first multiplier BI_U received from the demultiplexer 151 in response to the register control signal R13 and outputs the stored first multiplier BI_U. The register 210 stores a second multiplier BI_L received from the demultiplexer 161 in response to the register control signal R23 and outputs the stored second multiplier BI_L. Each of the first and second multipliers BI_U and BI_L has the length of W bits (W is an integer). The length of W bits corresponds to a data bus width of each of the first and second memories 640 and 650. During one operation, the Montgomery multiplier 200 requires a modulus and multiplicand of a chunk unit. Because the Montgomery multiplier 200 uses a digit length multiplier for each operation, a register for storing multipliers need not to store a chunk length multiplier. As a result, it is sufficient if the registers 205 and 210 have spaces capable of storing the same bit length as a data bus width of each of the first and second memories 640 and 650.

The register 211 stores a first accumulation result input signal SI_U received from one of the multiplexers 151 and 161 in response to the register control signal R14, and outputs the stored first accumulation result input signal SI_U. The register 212 stores a second accumulation result input signal SI_L received from the demultiplexer 161 in response to the register control signal R24 and outputs the stored second accumulation result input signal SI_L. The first and second accumulation result signals SI_U and SI_L are accumulation results obtained through the previous operations by the accumulator 270. The first and second accumulation result input signals SI_U and SI_L have the lengths of C bits.

The register 213 stores a first output accumulation signal QO_U received from the first modulus recorder 251 in response to the register control signal R15, and outputs the stored first output accumulation signal QO_U to the demultiplexer 151 of the first signal pass circuit 150. The register 214 stores a first input accumulation signal QI_U received from the demultiplexer 151 in response to the register control signal R16 and outputs the stored first input accumulation signal QI_U to the first modulus recorder 251. The first output accumulation signal QO_U is created by the first modulus recorder 251 during an initial operation of the Montgomery multiplier 200.

The register 215 stores a second output accumulation signal QO_L received from the second modulus recorder 252 in response to a register control signal R25 and outputs the stored second output accumulation signal QO_L to the multiplexer 162 of the second signal pass circuit 160. The register 216 stores a second input accumulation signal QI_L received from the demultiplexer 161 in response to a register control signal R26 and outputs the stored second input accumulation signal QI_L to the second modulus recorder 252. The second output accumulation signal QO_L is created by the modulus recorder 252 during the initial operation of the Montgomery multiplier 200.

The register 221 stores a first accumulation result output signal SO_U received from the accumulator 270 in response to a register control signal R17 and outputs the stored first accumulation result output signal SO_U to the multiplexer 152. The register 222 stores a second accumulation result output signal SO_L received from the accumulator 270 in response to a register control signal R27 and outputs the stored second accumulation result output signal SO_L to the multiplexer 162.

The register 223 stores a first added result signal ZO_U received from the carry propagation adder 280 in response to the register control signal R18 and outputs the stored first added result signal ZO_U to the multiplexer 152. The register 224 stores one of a second added result signal ZO_L and a third added result signal ZO_M received from the carry propagation adder 280 in response to the register control signal R28, and outputs the stored signal to the multiplexer 162.

The multiplexer 231 selects and outputs one of the first moduli MX_U and MY_U received from the registers 201 and 202 in response to one of the selection signals SM1 and SM3. The multiplexer 233 selects and outputs one of the second moduli MX_L and MY_L received from the registers 206 and 207 in response to one of the selection signals SM2 and SM3. The multiplexer 232 selects and outputs one of the first multiplicands AX_U and AY_U received from the registers 203 and 204 in response to one of the selection signals SP1 and SP3. The multiplexer 234 selects and outputs one of the second multiplicands AX_L and AY_L received from the registers 208 and 209 in response to one of the selection signals SP2 and SP3.

The first multiple modulus generator 241 generates a first multiple modulus signal MM_U on the basis of the first accumulation result input signal SI_U received from the register 211 and an output signal of the multiplexer 231, in response to one of generation control signals EM1 and EM3. The second multiple modulus generator 243 generates a second multiple modulus signal MM_L on the basis of the second accumulation result input signal SI_L received from the register 212 and an output signal of the multiplexer 233, in response to one of the generation control signals EM2 and EM3. The first partial product generator 242 generates a first partial product signal PP_U on the basis of an output signal of the multiplexer 232, in response to one of generation control signals EP2 and EP3. The second partial product generator 244 generates a second partial product signal PP_L on the basis of an output signal of the multiplexer 234, in response to one of the generation control signals EP2 and EP3.

The first modulus recorder 251 is controlled by a recording control signal RCTL1, and generates the selection signal SM1, the generation control signal EM1 and an accumulation control signal NEG_MM_U, on the basis of predetermined lower bits AU_LSB of the first accumulation result input signal SI_U, predetermined lower bits MU_LSB of the first multiple modulus signal MM_U and predetermined lower bits PU_LSB of the first partial product signal PP_U. In the first operation mode, the first modulus recorder 251 is enabled or disabled and in the second operation mode, the first modulus recorder 251 is disabled.

The second modulus recorder 252 generates one of the selection signals SM2 and SM3, one of the generation control signals EM2 and EM3 and an accumulation control signal NEG_MM_L, on the basis of predetermined lower bits AL_LSB of the second accumulation result input signal SI_L, predetermined lower bits ML_LSB of the second multiple modulus signal MM_L and predetermined lower bits PL_LSB of the second partial product signal PP_L, under the control of a recording control signal RCTL2.

The first booth recorder 261 generates the selection signal SP1, the generation control signal EP1 and an accumulation control signal NEG_PP_U on the basis of the first multiplier BI_U received from the register 205, under the control of a recording control signal RCTL3. The second booth recorder 262 generates one of the selection signals SP2 and SP3, one of the generation control signals EP2 and EP3 and an accumulation control signal NEG_PP_L on the basis of the second multiplier BI_L received from the register 210, under the control of a recording control signal RCTL4.

The accumulator 270 receives the first and second multiple modulus signals MM_U and MM_L, the first and second partial product signals PP_U and PP_L and the accumulation control signals NEG_MM_U, NEG_MM_L, NEG_PP_U and NEG_PP_L. The accumulator 270 operates in one of the first operation mode and the second operation mode in response to a mode control signal PCTL and a shifting signal SFT. In the first operation mode, the accumulator 270 performs two independent accumulation operations for the received signals at the same time, and outputs the accumulation results as first and second carry signals C_U and C_L, first and second sum signals S_U and S_L and first and second accumulation result output signals SO_U and SO_L. In the first operation mode, the accumulator 270 performs only one of the two accumulation operations, and outputs the accumulation results as the first carry signal C_U, the first sum signal S_U and the first accumulation result output signal SO_U, or as the second carry signal C_U, the second sum signal S_L and the second accumulation result signal SO_L.

In the second operation mode, the accumulator 270 performs an accumulation operation and outputs the accumulation results as the first and second carry signals C_U and C_L, the first and second sum signals S_U and S_L and the second accumulation result output signal SO_L.

The carry propagation adder 280 adds the first carry signal C_U with the first sum signal S_U to output a first added result signal ZO_U, and adds the second carry signal C_L with the second sum signal S_L to output a second added result signal ZO_L. The carry propagation adder 280 adds the first and second carry signals C_U and C_L with the first and second sum signals S_U and S_U for each W bits to output a third added result signal ZO_M.

Alternately, among components of the Montgomery multiplier 200 shown in FIG. 2, the registers 202, 204, 207 and 209 and the multiplexers 231 through 234 can be omitted. In this case, the registers 201, 203, 206 and 208 are connected directly to the first multiple modulus generator 241, the first partial product generator 242, the second multiple modulus generator 243 and the second partial product generator 244, respectively.

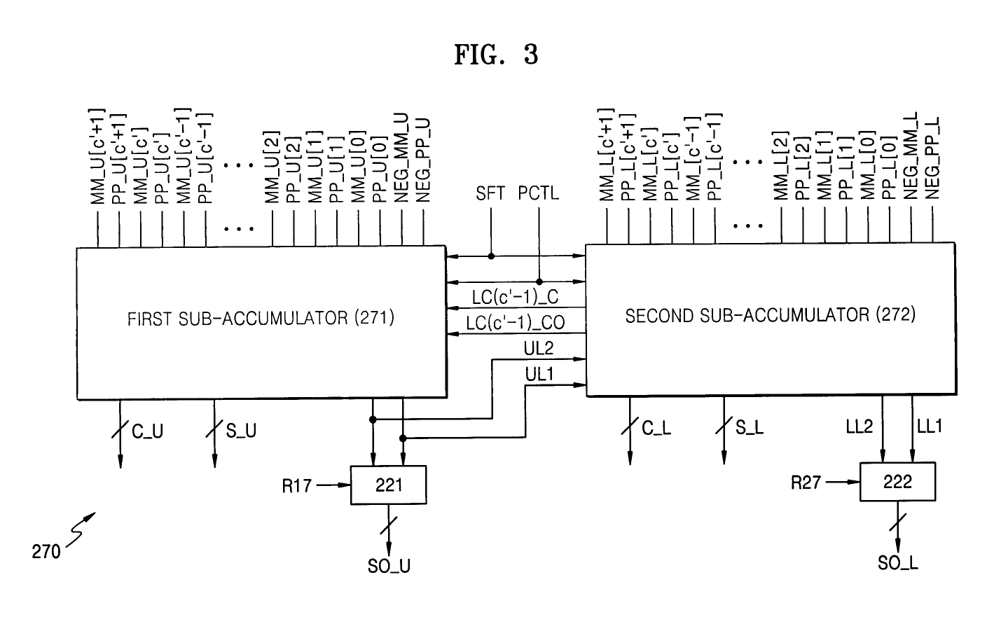

FIG. 3 is a block diagram of the accumulator 270 shown in FIG. 2. Referring to FIG. 3, the accumulator 270 includes a first sub-accumulator 271 and a second sub-accumulator 272. The first sub-accumulator 271 and the second sub-accumulator 272 are separated from each other or connected to each other in response to the mode control signal PCTL. In more detail, if the mode control signal PCTL is enabled, the first and second sub-accumulators 271 and 272 are separated from each other, and if the mode control signal PCTL is disabled, the first and second sub-accumulators 271 and 272 are connected to each other. If the first and second sub-accumulators 271 and 272 are separated from each other, two independent accumulation operations are performed respectively and if the first and second sub-accumulators 271 and 272 are connected to each other, an accumulation operation is performed.

The first sub-accumulator 271 receives the first multiple modulus signal MM_U, the first partial product signal PP_U and the accumulation control signals NEG_MM_U and NEG_PP_U. The first multiple modulus signal MM_U includes bits MM_U[0] through MM_U[c′+1] and the first partial product signal PP_U includes bits PP_U[0] through PP_U[c′+1]. Here, c′is an extended 1/₂ chunk length and can be expressed by Equation 6:

$${c}^{′} = C + \frac{W}{2} \qquad ( 6 )$$

In Equation 6, C is a ½ chunk length and W is the data bus width of each of the first and second memories 640 and 650.

The first sub-accumulator 271 further receives a carry signal LC(c′−1)_C and an output carry signal LC(c′−1)_CO from the second sub-accumulator 272. The first sub-accumulator 271 outputs a first carry signal C_U and a first sum signal S_U as accumulation results and outputs a first accumulation result output signal SO_U including first lower values signals UL1 and UL2 to the register 221.

The second sub-accumulator 272 receives the second multiple modulus signal MM_L, the second partial product signal PP_L and the accumulation control signals NEG_MM_L and NEG_PP_L. The second multiple modulus signal MM_L includes bits MM_L[0] through MM_L[c′+1] and the second partial signal PP_L includes bits PP_L[0] through PP_L[c′+1]. The second sub-accumulator 272 further receives the first lower value signals UL1 and UL2 from the first sub-accumulator 271. The second sub-accumulator 272 outputs a second carry signal C_L and a second sum signal S_L as accumulation results and outputs the second accumulation result output signal SO_L including second lower value signals LL2 and LL2 to the register 222.

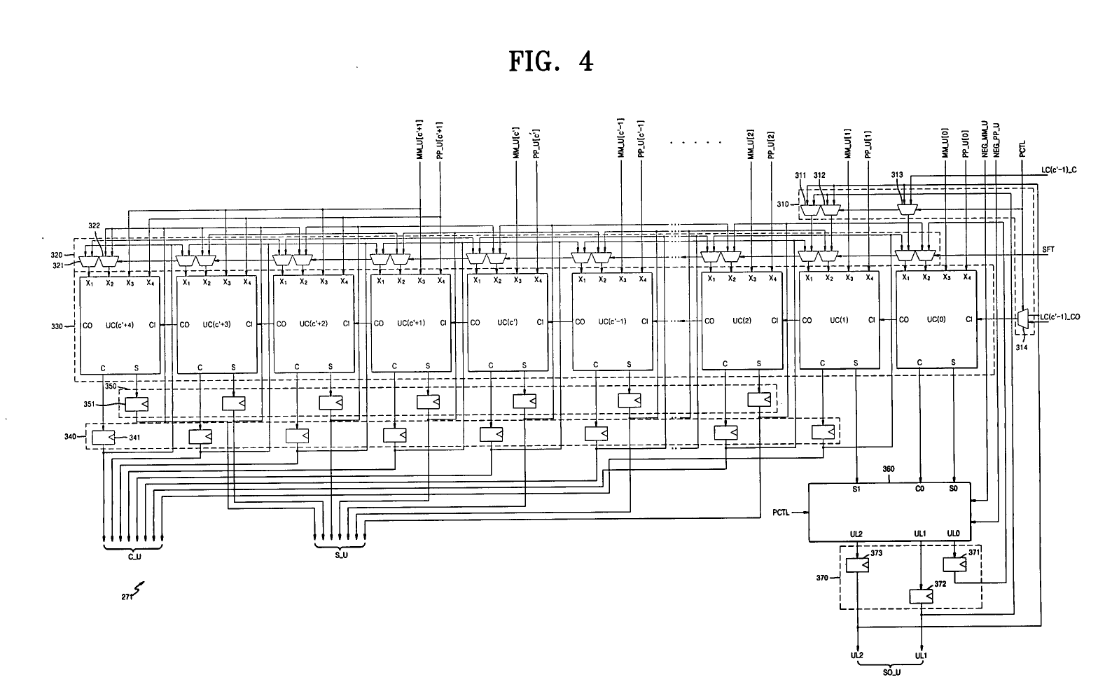

FIG. 4 is a detailed block diagram of the first sub-accumulator 271 shown in FIG. 3. Referring to FIG. 4, the first sub-accumulator 271 includes selection circuits 310 and 320, a compressor unit 330, a carry register unit 340, a sum register unit 350, a first lower value generator 360 and a first lower value register unit 370. The selection circuit 310 includes multiplexers 311 through 314. The multiplexers 311 and 312 select and output one of the first lower value signals UL1 and UL2 in response to the mode control signal PCTL. In more detail, when the mode control signal PCTL is enabled, the multiplexer 311 outputs the first lower value signal UL2 and the multiplexer 312 outputs the first lower value signal UL1. The multiplexer 313 selects and outputs one of the first lower value signal UL2 and the carry signal LC(c′−1)_C in response to the mode control signal PCTL. In more detail, when the mode control signal PCTL is enabled, the multiplexer 313 outputs the first lower value signal UL2 and when the mode control signal PCTL is disabled, the multiplexer 313 outputs the carry signal LC(c′−1)_C. The multiplexer 314 selects and outputs one of the first lower value signal UL2 and the output carry signal LC(c′−1)_CO in response to the mode control signal PCTL. In more detail, when the mode control signal PCTL is enabled, the multiplexer 314 outputs the first lower value signal UL2 and then outputs the output carry signal LC(c′−1)_CO.

The selection circuit 320 includes a plurality of first multiplexers 321 and a plurality of second multiplexers 322. Each of the first and second multiplexers 321 and 322 selects and outputs one of two input signals in response to a shifting signal SFT.

The compressor unit 330 includes a plurality of compressors UC(0) through UC(c′+4) serially connected to each other, wherein each of the plurality of compressors UC(0) through UC(c′+4) includes first through fourth input terminals X1 through X4, first and second output terminals C and S, a carry input terminal C1 and a carry output terminal CO. Each first input terminal X1 of each of the plurality of compressors UC(0) through UC(c′+1) is connected to an output terminal of the first multiplexer 321. Each second input terminal X2 of each of the plurality of compressors UC(0) through UC(c′+1) is connected to an output terminal of the second multiplexer 322. The bits MM_U[0] through MM_U[c′+1] are input to the respective third input terminals X3 of the plurality of compressors UC(0) through UC(c′+1), respectively, and the bits PP_U[0] through PP_U[c′+1] are input to the respective fourth input terminals X4 of the plurality of compressors UC(0) through UC(c′+1), respectively. The bits MM_U[c′+1] are input to the respective third input terminals X3 of the compressors UC(c′+2) through UC(c′+4), respectively, and the bits PP_U[c′+1] are input to the respective fourth input terminals X4 of the compressors UC(c′+2) through UC(c′+4), respectively. Each of the first multiplexers 321, which are connected to the respective first input terminals X1 of the compressors UC(2) through UC(c′+3), selects and outputs one of a carry signal of a 1-bit upper compressor and a carry signal of a 1-bit lower compressor, in response to the shifting signal SFT. For the convenience of descriptions, carry signals and sum signals output from the compressors UC(0) through UC(c′+4) are referred to as UC(0)_C through UC(c′+4)_C and UC(0)_S through UC(c′+4)_S, respectively.

For example, the first multiplexer 321 connected to the first input terminal X1 of the compressor UC(c′+1) selects and outputs one of a carry signal UC(c′+2)_C of the compressor UC(c′+2) and a carry signal UC(c′)_C of the compressor UC(c′).

The first multiplexer 321 connected to the first input terminal X1 of the compressor UC(c′+4) selects and outputs one of a carry signal UC(c′+3)_C of the compressor UC(c′+3) and a carry signal UC(c′+4)_C of the compressor UC(c′+4), in response to the shifting signal SFT. The first multiplexer 321 connected to the first input terminal X1 of the compressor UC(1) selects and outputs one of a carry signal UC(2)_C of the compressor UC(2) and an output signal of the multiplexer 311. The first multiplexer 321 connected to the first input terminal X1 of the compressor UC(0) selects and outputs one of a carry signal UC(1)_C of the compressor UC(1) and an output signal of the multiplexer 313.

Each of the second multiplexers 322 connected to the respective input terminals X2 of the compressors UC(2) through UC(c′+2) selects and outputs one of a sum signal of a 2-bit upper compressor and a sum signal of a corresponding compressor, in response to the shifting signal SFT. For example, the second multiplexer 322 connected to the second input terminal X2 of the compressor UC(c′+1) selects and outputs one of a sum signal UC(c′+3)_S of the compressor UC(c′+3) and a sum signal UC(c′+1)_S of the compressor UC(c′+1).

The second multiplexer 322 connected to the second input terminal X2 of the compressor UC(c′+3) selects and outputs one of the sum signal UC(c′+4)_S of the compressor UC(c′+4) and the sum signal UC(c′+3)_S of the compressor UC(c′+3), in response to the shifting signal SFT. The sum signal UC(c′+4)_S of the compressor UC(c′+4) is input to two input terminals of the second multiplexer 322 connected to the second input terminal X2 of the compressor UC(c′+4).

The second multiplexer 322 connected to the second input terminal X2 of the compressor UC(1) selects and outputs one of the sum signal UC(3)_S of the compressor UC(3) and an output signal of the multiplexer 312, in response to the shifting signal SFT. The second multiplexer 322 connected to the second input terminal X2 of the compressor UC(0) selects and outputs one of the sum signal UC(2)_S of the compressor UC(2) and a first lower value signal UL0, in response to the shifting signal SFT.

The carry input terminal CI of the compressor UC(0) is connected to the output terminal of the multiplexer 314 and respective carry input terminals CI of the compressors UC(1) through UC(c′+4) are connected to carry output terminals CO of corresponding 1-bit lower compressors, respectively. For example, the carry input terminal CI of the compressor UC(c′+4) is connected to the carry output terminal CO of the compressor UC(c′+3), and the carry input terminal CI of the compressor UC(c′+3) is connected to the carry output terminal CO of the compressor UC(c′+2).

The compressors UC(0) through UC(c′+4) output the carry signals UC(0)_C through UC(c′+4)_C and the sum signals UC(0)_S through UC(c′+4)_S, respectively, in response to signals input to the first through fourth input terminals X1 through X4 and the carry input terminal CI.

The carry register unit 340 includes a plurality of carry registers 341 and the sum register unit 350 also includes a plurality of sum registers 351. The carry registers 341 store the carry signals UC(1)_C through UC(c′+4)_C, respectively, and output the stored carry signals UC(1)_C through UC(c′+4)_C, respectively. The sum registers 351 store the sum signals UC(2)_S through UC(c′+4)_S, respectively and output the stored sum signals UC(2)_S through UC(c′+4)_S, respectively. The first carry signal C_U includes the carry signals UC(1)_C through UC(c′+4)_C and the first sum signal S_U includes the sum signals UC(2)_S through UC(c′+4)_S.

The first lower value generator 360 receives the carry signal UC(0)_C, the sum signals UC(0)_S through UC(1)_S and the accumulation control signals NEG_MM_U and NEG_PP_U, and outputs first lower value signals UL0 through UL2 in response to the mode control signal PCTL. The first lower value signals UL0 through UL2 are stored in the registers 371 through 373 of the first lower value register unit 370, respectively, and then the stored signals are outputted. The first accumulation result output signal SO_U includes the first lower value signals UC1 and UC2.

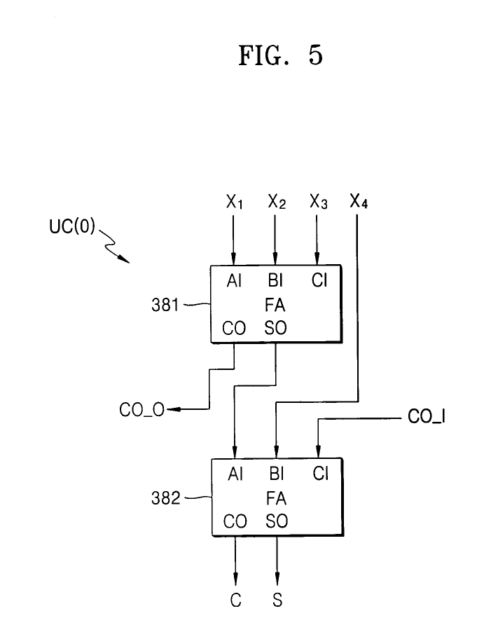

Hereinafter, the compressors UC(0) through UC(c′+4) will be described in more detail with reference to FIG. 5. The detailed configuration and operations of the compressors UC(1) through UC(c′+4) are substantially the same as those of the compressor UC(0) and therefore descriptions will be given on the basis of the compressor UC(0). FIG. 5 is a detailed block diagram of the compressor UC(0) shown in FIG. 4, that is, a 4-2 compressor. Referring to FIG. 5, the compressor UC(0) includes a first full adder 381 and a second full adder 382. The first full adder 381 outputs a full added carry signal CO_O and a full added sum signal SO_O in response to input signals received via the first through third input terminals X1 through X3. The second full adder 382 outputs a full added carry signal C and a full added sum signal S in response to the full added sum signal SO_O, an signal input to the fourth input terminal X4, and an output carry signal CO_I received from a 1-bit lower compressor.

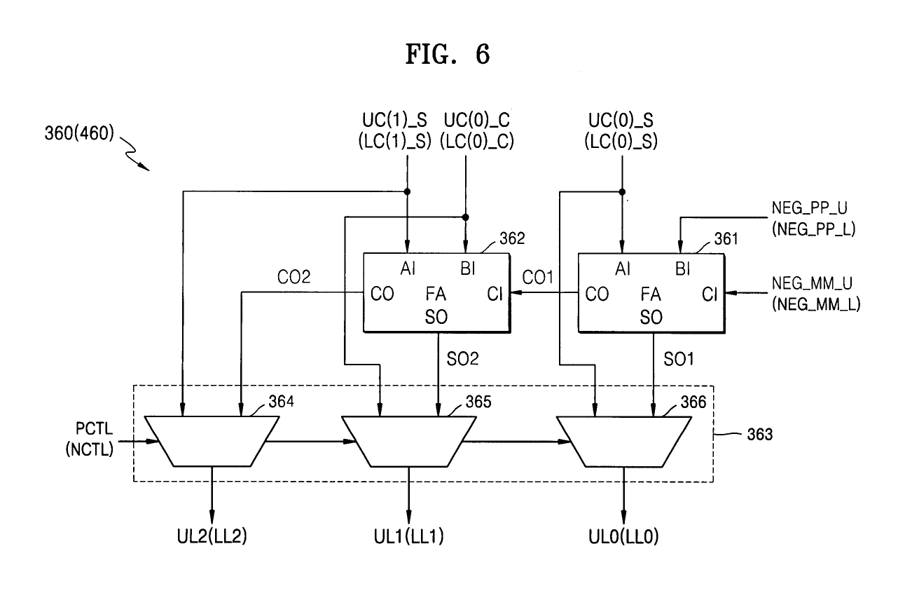

FIG. 6 is a detailed block diagram of the first lower value generator 360 shown in FIG. 4. Referring to FIG. 6, the first lower value generator 360 includes a first full adder 361, a second full adder 362 and an output selection circuit 363. The first full adder 361 outputs a full added carry signal C01 and a full added sum signal S01 in response to the accumulation control signals NEG_MM_U and NEG_PP_U and a sum signal UC(0)_S of the compressor UC(0). The second full adder 362 outputs a full added carry signal CO₂ and a full added sum signal SO₂ in response to the full added carry signal C01, the sum signal UC(1)_S of the compressor UC(1) and the carry signal UC(0)_C of the compressor UC(0). The output selection circuit 363 includes multiplexers 364 through 366. The multiplexer 364 selects one of the sum signal UC(1)_S and the full added carry signal CO₂ in response to the mode control signal PCTL and outputs the selected signal as the first lower value signal UL2. In more detail, when the mode control signal PCTL is enabled, the multiplexer 364 outputs the full added carry signal CO₂ as the first lower value signal UL2 and when the mode control signal PCTL is disabled, the multiplexer 364 outputs the sum signal UC(1)_S as the first lower value signal UL2. The multiplexer 365 selects one of the carry signal UC(0)_C and the full added sum signal SO₂ in response to the mode control signal PCTL and outputs the selected signal as the first lower value signal UL1. In more detail, when the mode control signal PCTL1 is enabled, the multiplexer 365 outputs the full added sum signal SO₂ as the first lower value signal UL1 and when the mode control signal PCTL is disabled, the multiplexer 365 outputs the carry signal UC(0)_C as the first lower value signal UL1. The multiplexer 366 selects one of the sum signal UC(0)_S and the full added sum signal SO2 in response to the mode control signal PCTL and outputs the selected signal as the first lower value signal UL0. In more detail, when the mode control signal is enabled, the multiplexer 366 outputs the full added sum signal S01 as the first lower value signal UL0 and when the mode control signal PCTL is disabled, the multiplexer 366 outputs the sum signal UC(0)_S as the first lower value signal UL0. As a result, when the mode control signal PCTL is disabled, the output selection circuit 363 outputs the carry signal UC(0)_C and the sum signals UC(1)_S and UC(0)_S as the first lower value signals UC2, UL2 and UL0, respectively.

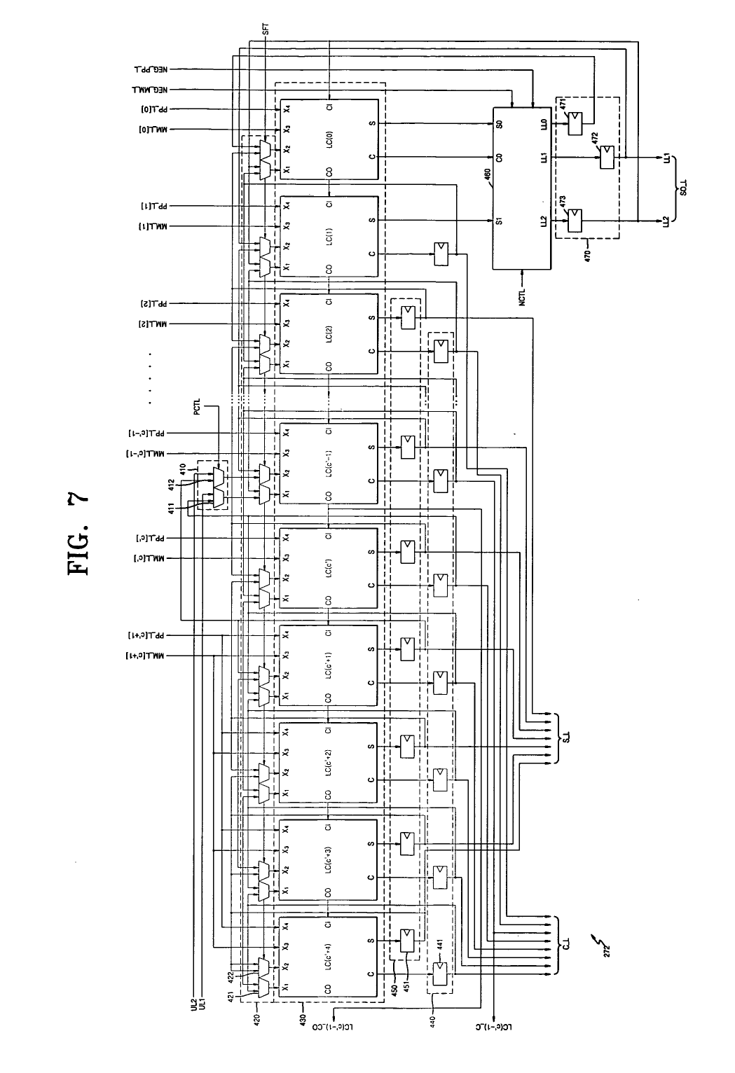

FIG. 7 is a detailed block diagram of the second sub-accumulator 272 shown in FIG. 3. Referring to FIG. 7, the second sub-accumulator 272 includes selection circuits 410 and 420, a compressor unit 430, a carry register unit 440, a sum register unit 450, a second lower value generator 460, and a second lower value register unit 470. The selection circuit 410 includes multiplexers 411 and 412. The multiplexer 411 selects and outputs one of a first lower value signal UL1 and a carry signal LC(c′)_C in response to the mode control signal PCTL. In more detail, when the mode control signal PCTL is enabled, the multiplexer 411 outputs the carry signal LC(c′)_C, and when the mode control signal PCTL is disabled, the multiplexer 411 outputs the first lower value signal UL1. The multiplexer 412 selects and outputs one of a first lower value signal UL2 and a sum signal LC(C′+1)_S in response to the mode control signal PCTL. In more detail, when the mode control signal PCTL is enabled, the multiplexer 412 outputs the sum signal LC(c′+1)_S and when the mode control signal PCTL is disabled, the multiplexer 213 outputs the first lower value signal UL2.

The selection circuit 420 includes a plurality of first multiplexers 421 and a plurality of second multiplexers 422. Each of the first and second multiplexers 421 and 422 selects and outputs one of two input signals in response to the shifting signal SFT.

The compressor unit 430 includes a plurality of compressors LC(0) through LC(c′+4) serially connected to each other and each of the plurality of compressors LC(0) through LC(c′+4) includes first through fourth input terminals X1 through X4, first and second output terminals C and S, a carry input terminal C₁, and a carry output terminal CO. The respective first input terminals X1 of the plurality of compressors LC(0) through LC(c′+4) are connected to the respective output terminals of the first multiplexer 421, respectively, and the respective second input terminals X2 of the plurality of compressors LC(0) through LC(c′+4) are connected to the respective output terminals of the second multiplexer 422, respectively.

The bits MM_L[0] through MM_L[c′+1] are input to the respective third input terminals X3 of the plurality of compressors LC(0) through LC(c′+1), respectively, and the bits PP_L[0] through PP_L[c′+1] are input to the respective the fourth input terminals X4 of the plurality of compressors LC(0) through LC(c′+1), respectively. The bits MM_L[c′+1] are input to the respective third input terminals X3 of the compressors LC(c′+2) through LC(c′+4) and the bits PP_L[c′+1] are input to the respective fourth input terminals X4 of the compressors LC(c′+2) through LC(c′+4), respectively. Each of the first multiplexers 321 connected to the first input terminals X1 of the compressors LC(2) through LC(c′−2) and LC(c′) through LC(c′+3) selects and outputs one of a carry signal of a 1-bit upper compressor and a carry signal of a 1-bit lower compressor. For the convenience of descriptions, carry signals and sum signals output from the compressors LC(0) through LC(c′+4) are referred to as LC(0)_C through LC(c′+4)_C and LC(0)_S through LC(c′+4)_S, respectively.

For example, the first multiplexer 421 connected to the first input terminal X1 of the compressor LC(c′+1) selects and outputs one of a carry signal LC(c′+2)_C of the compressor LC(c′+2) and a carry signal LC(c′)_C of the compressor LC(c′), in response to the shifting signal SFT. The first multiplexer 421 connected to the first input terminal X1 of the compressor UC(c′+4) selects and outputs one of a carry signal LC(c′+4) of the compressor LC(c′+4) and a carry signal LC(c′+3)_C of the compressor LC(c′+3) in response to the shifting signal SFT. The first multiplexer 421 connected to the first input terminal X1 of the compressor LC(c′−1) selects and outputs one of an output signal of the multiplexer 411 and a carry signal LC(c′−2)_C of the compressor LC(c′−2). The first multiplexer 421 connected to the first input terminal X1 of the compressor LC(1) selects and outputs one of a carry signal LC(2)_C of the compressor LC(2) and a second lower value signal LL2. The first multiplexer 421 connected to the first input terminal X1 of the compressor LC(0) selects and outputs one of a carry signal LC(1)_C of the compressor LC1 and the second lower value signal LL2.

Each of the second multiplexers connected to the second input terminals X2 of the compressors LC(2) through LC(c′−2) and LC(c′) through LC(c′+2) selects and outputs one of a sum signal of a 2-bit upper compressor and a sum signal of a corresponding compressor, in response to the shifting signal SFT. For example, the second multiplexer 422 connected to the second input terminal X2 of the compressor LC(c′+1) selects and outputs one of a sum signal LC(c′+3) of the compressor LC(c′+3) and a sum signal LC(c′+1)_S of the compressor LC(c′+1).

The second multiplexer 422 connected to the second input terminal X2 of the compressor LC(c′+3) selects and outputs one of the sum signal LC(c′+4)_S of the compressor LC(c′+4) and the sum signal LC(c′+3)_S of the compressor LC(c′+3), in response to the shifting signal SFT. The sum signal LC(c′+4)_S of the compressor LC(c′+4) is input to two input terminals of the second multiplexer 422 connected to the second input terminal X2 of the compressor LC(c′+4). The second multiplexer 422 connected to the second input terminal X2 of the compressor LC(c′−1) selects and outputs one of an output signal of the multiplexer 412 and a sum signal LC(c′−1)_S of the compressor LC(c′−1). The second multiplexer 422 connected to the second input terminal X2 of the compressor LC(1) selects and outputs one of a sum signal LC(3)_S of the compressor LC(3) and the lower value signal LL1 in response to the shifting signal SFT. The second multiplexer 422 connected to the second input terminal X2 of the compressor LC(0) selects and outputs one of a sum signal LC(2)_S of the compressor LC(2) and a second lower value signal LL0 in response to the shifting signal SFT.

The second lower value signal LL2 is input to the carry input terminal C1 of the compressor LC(0) and each carry input terminal CI of each of the compressors LC(1) through LC(c′+4) is connected to a carry output terminal CO of a 1-bit lower compressor. For example, the carry input terminal CI of the compressor LC(c′+4) is connected to the carry output terminal CO of the compressor LC(c′+3) and the carry input terminal CI of the compressor LC(c′+3) is connected to the carry output terminal CO of the compressor LC(c′+2).

The compressors LC(0) through LC(c′+4) output carry signals LC(0)_C through LC(c′+4)_C and sum signals LC(0)_S through LC(c′+4)_S, respectively, in response to the first through fourth input terminals X1 through X4 and signals input to the carry input terminal CI. The detailed configurations and operations of the compressors LC(0) through LC(c′+4) are substantially the same as those of the compressor UC(0) shown in FIG. 5 and therefore detailed descriptions thereof are omitted.

The carry register unit 440 includes a plurality of carry registers 441 and the sum register unit 450 also includes a plurality of sum registers 451. The carry registers 441 store the carry signals LC(1)_C through LC(c′+4)_C, respectively, and output the stored carry signals LC(1)_C through LC(c′+4)_C, respectively. The sum registers 451 store the sum signals LC(2)_S through LC(c′+4)_S and output the stored sum signal LC(2)_S through LC(c′+4)_S, respectively. The second carry signal C_L includes the carry signals LC(1)_C through LC(c′+4)_C and the sum signal S_L includes the sum signals LC(2)_S through LC(c′+4)_S.

The second lower value generator 460 receives the sum signals LC(1)_S and LC(0)_S, the carry signal LC(0)_C and the accumulation control signals NEG_MM_L and NEG_PP_L, and outputs the second lower value signals LL0 through LL2 in response to an internal control signal NCTL. The second lower value signals LL0 through LL2 are stored in the registers 471 through 473 of the second lower value register unit 470, respectively, and then the stored signals are output. The second accumulation result output signal SO_L includes the second lower value signals LC1 and LC2. Preferably, the internal control signal NCTL, which is a signal generated in the second sub-accumulator 272, is maintained in a logic high level. The configuration and detailed operations of the second lower value generator 460 are similar with those of the first lower value generator 360 and therefore detailed descriptions thereof are omitted.

Hereinafter, the operations of the modular multiplier 100 will be described in detail with reference to FIGS. 1 through 7. The modular multiplier 100 can have a first operation mode and a second operation mode. First, the first operation mode of the modular multiplier 100 is described. Referring to FIG. 1, a control data signal PDW for the first operation mode is written in the control register 111 of the host interface 110 by a host 611. The host interface 110 outputs an operation information signal OP_INF on the basis of the control data signal PDW.

The controller 120 enables a mode control signal PCTL and outputs a shifting signal SFT, in response to the operation information signal OP_INF. The controller 120 enables both or one of first and second enable signals EN1 and EN2, in response to the operation information signal OP_INF. In more detail, if the operation information signal OP_INF includes information related to independent operations for two groups of operands each with a half of an operation length capable of being processed by the Montgomery multiplier 200, like the RSA algorithm, the controller 120 enables both the first and second enable signals EN1 and EN2. Also, if the operation information signal OP_INF includes information related to operations for operands each with an operation length shorter than an operation length capable of being processed by the Montgomery multiplier 200, like the ECC algorithm, the controller 120 enables one of the first and second enable signals EN1 and EN2.

In the first operation mode, a case where the controller 120 enables both the first and second enable signals EN1 and EN2 is first described. The controller 120 outputs a memory access request signal AREQ, recording control signals RCTL1 through RCTL4, register control signals R11 through R18 and R21 through R28, and first and second control signals ICTL1 and ICTL2, in response to the operation information signal OP_INF. The Montgomery multiplier 200 operates in the first operation mode in response to the mode control signal PCTL. The memory arbiter (630 of FIG. 8) assigns an access authority to the first and second memories (640 and 650 of FIG. 8) to the modular multiplier 100, in response to the memory access request signal AREQ.

Both the first and second memory interfaces 141 and 142 are enabled in response to the first and second enable signals EN1 and EN2. The first memory interface 141 reads first moduli MX_U and MY_U, first multiplicands AX_U and AY_U, a first multiplier BI_U and a first accumulation result input signal SI_U, from the first memory 640, in response to the first control signal ICTL1. The first memory interface 141 sequentially generates selection control signals SEL 11 through SEL 17, and outputs the read first moduli MX_U and MY_U, the first multiplicands AX_U and AY_U, the first multiplier BI_U and the first accumulation result input signal SI_U, sequentially, to the demultiplexer 151 of the first signal pass circuit 150. The demultiplexer 151 outputs the first moduli MX_U and MY_U, the first multiplicands AX_U and AY_U, the first multiplier BI_U and the first accumulation result input signal SI_U, sequentially, to the Montgomery multiplier 200, in response to the selection control signals SEL11 through SEL 17. The registers 201 through 205, 211 of the Montgomery multiplier 200 store the first moduli MX_U and MY_U, the first multiplicands AX_U and AY_U, the first multiplier BI_U and the first accumulation result input signal SI_U, sequentially, in response to the register control signals R11 through R14. The first moduli MX_U and MY_U, the first multiplicands AX_U and AY_U, the first multiplier BI_U and the first accumulation result input signal SI_U are written in advance in the first memory 640 by the host 611.

The second memory interface 142 reads second moduli MX_L and MY_L, second multiplicands AX_L and AY_L, a second multiplier BI_L and a second accumulation result input signal SI_L, from the second memory 650, in response to the second control signal ICTL2. The second memory interface unit 142 sequentially generates selection control signals SEL21 through SEL27, and outputs the read second moduli MX_L and MY_L, the second multiplicands AX_L and AY_L, the second multiplier BI_L and the second accumulation result input signal SI_L, sequentially, to the demultiplexer 161 of the second signal pass circuit 160. The demultiplexer 161 outputs the second moduli MX_L and MY_L, the second multiplicands AX_L and AY_L, the second multiplier BI_L and the second accumulation result input signal SI_L, sequentially, to the Montgomery multiplier 200, in response to the selection control signals SEL21 through SEL27. The registers 206 through 210, 212 of the Montgomery multiplier 200 store second moduli MX_L and MY_L, the second multiplicands AX_L and AY_L, the second multiplier BI_L and the second accumulation result input signal SI_L, sequentially, in response to the register control signals R21 through R24. The second moduli MX_L and MY_L, the second multiplicands AX_L and AY_L, the second multiplier BI_L and the second accumulation result input signal SI_L are written in advance in the second memory 650 by the host 611.

The first modulus recorder 251 generates a selection signal SM1, a generation control signal EM1 and an accumulation control signal NEG_MM_U under the control of the recording signal RCTL1. The second modulus recorder 252 generates a selection signal SM2, a generation control signal EM2 and an accumulation control signal NEG_MM_L under the control of the recording control signal RCTL2. The first booth recorder 261 generates a selection signal SP1, a generation control signal EP1 and an accumulation control signal NEG_PP_U on the basis of the first multiplier BI_U, under the control of the recording control signal RCTL3. The second booth recorder 262 generates a selection signal SP2, a generation control signal EP2 and an accumulation control signal NEG_PP_L on the basis of the second multiplier BI_L, under the control of the recording control signal SCTL4.

The multiplexers 231 and 233 output the first modulus MX_U and the second modulus MX_L in response to the selection signals SM1 and SM2, respectively. The multiplexers 232 and 234 output the first multiplicand AX_U and the second multiplicand AX_L in response to the selection signals SP1 and SP2, respectively. The multiple modulus generator 241 generates a first multiple modulus signal MM_U on the basis of the first accumulation result input signal SI_U and the first modulus MX_U received from the multiplexer 231, in response to the generation control signal EM1. The second multiple modulus generator 243 generates a second multiple modulus signal MM_L on the basis of the second accumulation result input signal SI_L and the second modulus MX_L received from the multiplexer 233, in response to the generation control signal EM2. The first partial product generator 242 generates a first partial product signal PP_U on the basis of the first multiplicand AX_U in response to the generation control signal EP1, and the second partial product generator 244 generates a second partial product signal PP_L on the basis of the second multiplicand AX_L.

The first sub-accumulator 271 and the second sub-accumulator 272 of the accumulator 270 are separated in response to the mode control signal PCTL and perform accumulation operations independently. The first sub-accumulator 271 outputs a first carry signal C_U, a first sum signal S_U and first lower value signals UL0 through UL2 on the basis of the first multiple modulus signal MM_U, the first partial product signal PP_U and the accumulation control signals NEG_MM_U and NEG_PP_U, in response to the shifting control signal SFT and the mode control signal PCTL. The first lower value signals UL1 and UL2 are stored as a first accumulation result output signal SO_U in the register 221. The second sub-accumulator 272 outputs a second carry signal C_L, a second sum signal S_L, and second lower value signals LL0 through LL2 on the basis of the second multiple modulus signal MM_L, the second partial product signal PP_L and the accumulation control signals NEG_MM_and NEG_PP_L, in response to the shifting signal SFT and the mode control signal PCTL. The second lower value signals LL1 and LL2 are stored as a second accumulation result output signal SO_L in the register 222.

The first modulus recorder 251 generates a first output accumulation signal QO_U on the basis of predetermined lower bits AU_LSB of the first accumulation result input signal SI_U, predetermined lower bits MU_LSB of the first multiple modulus signal MM_U, and predetermined lower bits PU_LSB of the first partial product signal PP_U, and the register 213 stores the first output accumulation signal QO_U. Thereafter, the first output accumulation signal QO_U is stored in the first memory 640. The first output accumulation signal QO_U stored in the first memory 640 is input as a first input accumulation signal QI_U to the first modulus recorder 251 when the Montgomery multiplier 200 performs the following operation. The first modulus recorder 251 generates the first output accumulation signal QO_U once when an initial operation is performed, and repeatedly reads and uses the first output accumulation signal QO_U from the first memory 640 whenever the following operations are performed.

The modulus recorder 252 generates a second output accumulation signal QO_L on the basis of the predetermined lower bits AL_LSB of the second accumulation result input signal SI_L, the predetermined lower bits ML_LSB of the second multiple modulus signal MM_L and the predetermined lower bits PL_LSB of the second partial product signal PP_L, and the register 215 stores the second output accumulation signal QO_L. Then, the second output accumulation signal QO_L is stored in the second memory 650. The second output accumulation signal QO_L stored in the second memory 650 is input as a second input accumulation signal QI_L to the second modulus recorder 252 when the Montgomery multiplier 200 performs the following operation. The second modulus recorder 252 generates the second output accumulation signal QO_L once when an initial operation is performed, and repeatedly reads and uses the second output accumulation signal QO_L from the second memory 650 whenever the following operations are performed.

The carry propagation adder 280 adds the first carry signal C_D with the first sum signal S_U to output a first added result signal ZO_U and adds the second carry signal C_L with the second sum signal S_L to output a second added result signal ZO_L. The first added result signal ZO_U is stored in the register 223 for each W bits corresponding to a data bus width of the first memory 640 and then output to the first memory interface 141 through the multiplexer 152 of the first signal pass circuit 150. The second added result signal ZO_L also is stored in the register 224 for each W bits corresponding to a data bus width of the second memory 650 and then output to the second memory interface 142 through the multiplexer 162 of the second signal pass circuit 160.

Thereafter, the first memory interface 141 sequentially generates selection control signals SEL 18 through SEL20 and writes the first accumulation result output signal SO_U, the first output accumulation signal QO_U and the first added result signal ZO_U received from the multiplexer 152, in the first memory 640. The second memory interface 142 sequentially generates selection control signals SEL28 through SEL30 and writes the second accumulation result output signal SO_L, the second output accumulation signal QO_U and the second added result signal ZO_U received from the multiplexer 162, in the second memory 650.

As described above, the modular multiplier 100 performs two modular multiplication operations independently and simultaneously in the first operation mode. The two modular multiplication operations may be the operation for obtaining Sₚ and the operation for obtaining S_{q} in the above Equation 5. As such, since the operation for obtaining Sₚ and the operation for obtaining S_{q} are simultaneously performed by the modular multiplier 100, errors are generated in both the operations without an error being generated in only one of the two operations when an attacker tries to generate errors in the cryptography system. As a result, since both the Sₚ and S_{q} include errors, the attacker cannot obtain values of p and q as secret information from the Sₚ and Sq. Accordingly, the modular multiplier 100 can assure stability against a side-channel attack such as DFA without additional operations for preventing the DFA.

Hereinafter, in the first operation mode, a case where the controller 120 enables one of the first and second enable signals EN1 and EN2 is described. For example, there is a case where the controller 120 enables the first enable signal EN1 and disables the second enable signal EN2. The first interface 141 is enabled in response to the first enable signal EN1 and the second interface 141 is disabled in response to the second enable signal EN2. The controller 120 outputs a memory access request signal AREQ, recording control signals RCTL1 and RCTL3, register control signals R11 through R18 and a first control signal ICTL1 in response to the operation information signal OP_INF. As a result, only the registers 201 through 205, 211, 213, 214, 221 and 223 of the Montgomery multiplier 200, the first modulus recorder 251, the first booth recorder 261, the multiplexers 231 and 232, the first multiple modulus generator 241, the first partial product generator 242, the accumulator 270, and the carry propagation adder 280 operate. The above devices operate in the same manner as described above and therefore the detailed descriptions for the above devices are omitted. The registers 206 through 210, 212, 215, 216, 222 and 224, the second modulus recorder 252, the second booth recorder 262, the multiplexers 233 and 234, the second multiple modulus generator 243 and the second partial product generator 244 are disabled and do not operate.

As a result, when operations for operands each with a length shorter than an operation length capable of being processed by the Montgomery multiplier 200, like the ECC algorithm, are performed, it is possible to reduce power consumption by operating only predetermined ones of the components of the modular multiplier 100 and disabling the remaining components.

Alternately, there is a case where the controller 120 enables the second enable signal EN2 and disables the first enable signal EN 1. In this case, the second memory interface 142 is enabled and the first memory interface 141 is disabled. The controller 120 outputs a memory access request signal AREQ, recording control signals RCTL2 and RCTL4, register control signals R21 through R28 and a second control signal ICTL2 in response to the operation information signal OP_INF. As a result, in the Montgomery multiplier 200, only the registers 206 through 210, 212, 210, 216, 222 and 224, the second modulus recorder 252, the second booth recorder 262, the multiplexers 233 and 234, the second multiple modulus generator 243, the second partial product generator 244, the accumulator 270 and the carry propagation adder 280 operate. The above devices operate in the same manner as described above and therefore the detailed descriptions for the above devices are omitted. Likewise, the registers 201 through 205, 211, 213, 214, 221 and 223, the first modulus recorder 251, the first booth recorder 261, the multiplexers 231 and 232, the first multiple modulus generator 241 and the first partial product generator 242 are disabled and do not operate.

Hereinafter, the second operation mode of the modular multiplier 100 is described. Referring to FIG. 1, a control data signal PDW for the second operation mode is written in the control register 111 of the host interface 110 by the host 611. The host interface 110 outputs an operation information signal OP_INF on the basis of the control data signal PDW.

The controller 120 disables a mode control signal PCTL in response to the operation information signal OP_INF and outputs a shifting signal SFT. The controller 120 enables the second enable signal EN2 and disables the first enable signal EN2 in response to the operation information signal OP_INF. The controller 120 outputs a memory access request signal AREQ, recording control signals RCTL2 and RCTL4, register control signals R11 through R18 and R21 through R28, and first and second control signals ICTL1 and ICTL2, in response to the operation information signal OP_INF. The Montgomery multiplier 200 operates in the second operation mode in response to the mode control signal PCTL. The memory arbiter 630 assigns an access authority to first and second memories 640 and 650 to the modular multiplier 100, in response to the memory access request signal AREQ.

The second memory interface 142 is enabled in response to the second enable signal EN2 and the first memory interface 141 is disabled in response to the first enable signal EN1. The first memory interface 141 outputs a chip selection signal MCS_U in response to the first control signal ICTL1 so that the second memory interface 142 can access the first memory 640. In the second operation mode, since the first memory interface 141 is disabled and does not output selection control signals SEL 11 through SEL 17 and SEL 18 through SEL20, the first signal pass circuit 150 also stops its operations.

The second memory interface 142 reads first and second multiplicands AX_U, AY_U, AX_L and AY_L and the first and second multipliers BI_U and BI_L from the first memory 640, in response to the second control signal ICTL2. The second memory interface 142 reads the first and second moduli MX_U, MY_U, MX_L and MY_U and first and second accumulation result input signals SI_U and SI_L from the second memory 650, in response to the second control signal ICTL2. The second memory interface 142 sequentially generates the selection control signals SEL21 through SEL25 in the state that a switching control signal SW_CTL is enabled, and sequentially outputs the read first moduli MX_U and MY_U, the first multiplicands AX_U and AY_U, the first multiplier BI_U and the first accumulation result input signal SI_U to the demultiplexer 161 of the second signal pass circuit 160.

The switching circuit 170 is turned on in response to the switching control signal SW_CTL so that predetermined ones of output lines of the multiplexers 151 and 161 are connected to each other. As a result, the first moduli MX_U and MX_U, the first multiplicands AX_U and AY_U, the first multiplier BI_U and the first accumulation result input signal SI_U output from the demultiplexer 161 are input to the registers 201 through 205, 211 of the Montgomery multiplier 200. Then, the second memory interface 142 sequentially generates the selection control signals SEL21 through SEL25 in the state that the switching control signal SW_CTL is disabled, and sequentially outputs the read second moduli MX_L and MY_L, the second multiplicands AX_L and AY_L, the second multiplier BI_L and the second accumulation result input signal SI_L to the demultiplexer 161. The switching circuit 170 is turned off in response to the switching control signal SW_CTL to decouple the output lines 153 and 163 of the multiplexers 151 and 161 from each other. As a result, the second moduli MX_L and MY_L, the second multiplicands AX_L and AY_L, the second multiplier BI_L, and the second accumulation result input signal SI_L output from the demultiplexer 161 are input to the registers 206 through 210, 212 of the Montgomery multiplier 200, respectively.

Then, the second modulus recorder 252 and the second booth recorder 262 operate under the control of the recording control signals RCTL2 and RCTL4. The first modulus recorder 251 and the first booth recorder 261 are disabled and do not operate.

The second modulus recorder 252 generates a selection signal SM3, a generation control signal EM3 and an accumulation control signal NEG_MM_U under the control of the recording control signal RCTL2. The second booth recorder 262 generates a selection signal SP3, a generation control signal EP3 and an accumulation control signal NEG_PP_L on the basis of the second multiplier BI_L under the control of the recording control signal RCTL4.

The multiplexers 231 and 233 output the first modulus MX_U and the second modulus MX_L, respectively, in response to the selection signal SM3. The multiplexers 232 and 234 output the first multiplicand AX_U and the second multiplicand AX_L, respectively, in response to the selection signal SP3. The first multiple modulus generator 241 generates a first multiple modulus signal MM_U on the basis of the first accumulation result input signal SI_U and the first modulus MX_U received from the multiplexer 231, in response to the generation control signal EM3. The second multiple modulus generator 243 generates a second multiple modulus signal MM_L on the basis of the second accumulation result input signal SI_L and the second modulus MX_L received from the multiplexer 233, in response to the generation control signal EM3. The first partial product generator 242 generates a first partial product signal PP_U on the basis of the first multiplicand AX_U in response to the generation control signal EP3 and the second partial product generator 244 generates a second partial product signal PP_L on the basis of the second multiplicand AX_L in response to the generation control signal EP3.

The first sub-accumulator 271 and the second sub-accumulator 272 of the accumulator 270 are coupled in response to the mode control signal PCTL and perform an accumulation operation. The first sub-accumulator 271 outputs a first carry signal C_U and a first sum signal S_U on the basis of the first multiple modulus signal MM_U, the first partial product signal PP_U and the accumulation control signals NEG_MM_U and NEG_PP_U in response to the shifting control signal SFT and the mode control signal PCTL. The second sub-accumulator 272 outputs a second carry signal C_L, a second sum signal S_L, and second lower value signals LL0 through LL2 on the basis of the second multiple modulus signal MM_L, the second partial product signal PP_L, and the accumulation control signals NEG_MM_L and NEG_PP_L, in response to the shifting signal SFT and the mode control signal PCTL. The second lower value signals LL1 and LL2 are stored as a second accumulation result output signal SO_L in the register 222.

The second modulus recorder 252 generates a second output accumulation signal QO_L on the basis of the predetermined lower bits AL_LSB of the second accumulation result input signal SI_L, the predetermined lower bits ML_LSB of the second multiple modulus signal MM_L and the predetermined lower bits PL_LSB of the second partial product signal PP_L, and the register 215 stores the second output accumulation signal QO_L. Then, the second output accumulation signal QO_L is stored in the second memory 650. The second output accumulation signal QO_L stored in the second memory 650 is input as a second input accumulation signal QI_L to the second modulus recorder 252 when the Montgomery multiplier 200 performs the following operation. The second modulus recorder 252 generates the second output accumulation signal QO_L once when an initial operation is performed and uses repeatedly the second output accumulation signal QO_L whenever the following operations are performed.

The carry propagation adder 280 adds the first and second carry signals C_U and C_L with the first and second sum signals S_U and S_L to output a third added result signal ZO_M. The third added result signal ZO_M is stored in the register 224 for each W bits corresponding to a data bus width of the second memory 650 and then output to the second memory interface 142 through the multiplexer 162 of the second signal pass circuit 160.

Thereafter, the second memory interface 142 generates sequential selection control signals SEL28 through SEL30 and writes the second accumulation result output signal SO_L, the second output accumulation signal QO_U and the third added result signal ZO_M received from the multiplexer 162 in the second memory 650.

FIG. 8 is a schematic block diagram of a cryptography system 600 including the modular multiplier according to the present invention. Referring to FIG. 8, the cryptography system 600 includes a modular multiplier 500, a host unit 610, a memory arbiter 630, and first and second memories 640 and 650. The host unit 610 includes a host 611, a peripheral bus interface 612, and a memory interface 613. The peripheral bus interface 612 is connected to a modular multiplier 500 through a peripheral bus 620. The memory interface 613 is connected to the first and second memories 640 and 650 through the memory arbiter 630. The host 611 outputs a control data signal to the modular multiplier 500 through the peripheral bus interface 612, controlling the operations of the modular multiplier 500. The host 611 writes operands to be used for the modular multiplier 500 in the first and second memories 640 and 650 through the memory interface 613, or reads operation result data of the modular multiplier 500 from the first and second memories 640 and 650. If the modular multiplier 500 receives a control data signal related to modular multiplication from the host 611, the modular multiplier 500 reads and processes the operands from the first and second memories 640 and 650 and stores the processed data in the first and second memories 640 and 650. The modular multiplier 500 independently and simultaneously performs two modular multiplication operations for half-sized operands stored in the first and second memories 640 and 650, in response to the control data signal, or performs a modular multiplication operation for full-sized operands stored in the first and second memories 640 and 650. The configuration and detailed operations of the modular multiplier 500 are similar to those of the modular multiplier 100 and therefore further descriptions thereof are omitted.

If the memory arbiter 630 receives a memory access request signal AREG from the modular multiplier 500, the memory arbiter 630 assigns an access authority to the first and second memories 640 and 650 to the modular multiplier 500. Also, if the memory arbiter 630 receives a memory access request signal BREQ from the host unit 610, the memory arbiter 630 assigns an access authority to the first and second memories 640 and 650 to the host unit 610.

Hereinafter, the operations of the cryptography system 600 will be described. First, the host unit 610 outputs the memory access request signal BREQ to the memory arbiter 630. Then, the host unit 610 transmits a chip selection signal HCS_U, a read/write command HWR, an address signal HAD and a write data signal HDW to the first memory 640 through the memory arbiter 630. The first memory 640 is enabled in response to the chip selection signal HCS_U and stores the write data signal HDW in a memory cell area corresponding to the address signal HAD in response to the read/write command HWR. The host unit 610 transmits a chip selection signal HCS_L, a read/write command HWR, an address signal HAD and a write data signal HDW to the second memory 650 through the memory arbiter 630. The second memory 650 is enabled in response to the chip selection signal HCS_L and stores the write data signal HDW in a memory cell area corresponding to the address signal HAD in response to the read/write command HWR. The write data signal HDW includes operands to be operated by the modular multiplier 500.

Then, the host unit 610 outputs the control data signal for controlling the operations of the modular multiplier 500. If the modular multiplier 500 receives the control data signal, the modular multiplier 500 outputs the memory access request signal AREQ to the memory arbiter 630. Then, the modular multiplier 500 transmits chip selection signals MCS_U and MCS_L, read/write commands MWR_U and MWR_L and address signals MAD_U and MAD_L to the first and second memories 640 and 650 through the memory arbiter 630. The first memory 640 is enabled in response to the chip selection signal MCS_U and reads and transmits the data signal MDR_U to the modular multiplier 500 in response to the read/write command MWR_U and the address signal MAD_U. The second memory 650 is enabled in response to the chip selection signal MCS_L and reads and transmits the data signal MDR_L to the modular multiplier 500 in response to the read/write command MWR_L and the address signal MAD_L. The data signals MDR_U and MDR_L include operands stored in advance in the first and second memories 640 and 650 by the host unit 610.

The modular multiplier 500 receives the data signals MDR_U and MDR_L, performs corresponding operations according to the control data signal and stores the operated result data MDW_U and MDW_L in the first and second memories 640 and 650. Hereinafter, the host unit 610 requests state information to the modular multiplier 500 to determine whether the operation of the modular multiplier 500 is terminated. If the operation of the modular multiplier 500 is terminated, the host unit 610 reads operation result data HDR including the operated result data MDW_U and MDW_L stored in the first and second memories 640 and 650 and performs encoding of data to be communicated.

As described above, using a segmentable modular multiplier according to some embodiments of the present invention, by simultaneously and independently performing a plurality of modular multiply operations, it is possible to increase stability and performance of a cryptography system.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A modular multiplier circuit comprising:
a control circuit configured to produce a mode control signal and operation control signals in response to a control signal; and
a calculator circuit configured to perform modular multiply operations on first and second bit length operands in respective first and second modes responsive to the mode control signal and the operation control signals.

2. The modular multiplier of claim 1, wherein the control circuit comprises:
a host interface unit configured to produce an operation information signal in response to a control data signal received from a host; and
a controller configured to produce the mode control signal and the operation control signals in response to the operation information signal.

3. The modular multiplier of claim 1, wherein in the first mode, the calculator circuit is configurable to independently and simultaneously perform modular multiply operations on first operands and second operands to produce respective first operation result signals and second operation result signals.

4. The modular multiplier of claim 3, wherein the first and second operands have the same bit length.

5. The modular multiplier of claim 3, wherein in the second mode, the calculator circuit performs a modular multiply operation on third operands having a bit length greater than the first and second operands.

6. The modular multiplier of claim 1, further comprising a memory interface circuit configured to receive operands from a first memory and a second memory and to provide the received operands to the calculator circuit.

7. The modular multiplier of claim 6:
wherein the memory interface comprises:
a first memory interface configured to be enabled or disabled in response to a first enable signal; and
a second memory interface configured to be enabled or disabled in response to the second enable signal; and
wherein the control circuit generates the first and second enable signals responsive to the control signal from the host.

8. The modular multiplier of claim 7, wherein, in the first mode, both the first and second memory interfaces are enabled, and in the second mode, the first memory interface is disabled and the second memory interface is enabled.

9. The modular multiplier of claim 8, wherein in the first mode, the first memory interface reads first multiplicands, first moduli and first multipliers from the first memory, transmits the first multiplicands, the first moduli and the first multipliers to the calculator circuit, and writes first operation results received from the calculator circuit in the first memory, and the second memory interface reads second multiplicands, second moduli, and second multipliers from the second memory, transmits the second multiplicands, the second moduli and the second multipliers to the calculator circuit and writes second operation results received from the calculator circuit to the second memory.

10. The modular multiplier of claim 9, wherein the first memory interface reads first operation results written in the first memory and transmits the read first operation results to the calculator circuit, and wherein the second memory interface reads second operation results written in the second memory and transmits the read second operation results to the calculator circuit.

11. The modular multiplier of claim 7, wherein in the second mode, the second memory interface reads multiplicands and multipliers from the first memory and moduli from the second memory, transmits the multiplicands, multipliers and moduli to the calculator circuit, and writes operation results received from the calculator circuit to the second memory.

12. The modular multiplier of claim 7, wherein in the first mode, one of the first memory interface and the second memory interface is enabled and the other of the first memory interface and the second memory interface is disabled.

13. The modular multiplier of claim 12, wherein in the first mode, the enabled one of the first and second memory interfaces reads multiplicands, moduli and multipliers from the first memory and the second memory, transmits the multiplicands, moduli and multipliers to the calculator circuit, and writes operation results received from the calculator circuit to one of the first memory or the second memory.

14. The modular multiplier of claim 7, wherein the operation control signals include a shifting signal, first through fourth recording control signals, and a plurality of register control signals.

15. The modular multiplier of claim 14, wherein the first memory interface outputs first selection control signals and second selection control signals in response to the first control signal, and the second memory interface outputs third selection control signals and fourth selection control signals in response to the second control signal.

16. The modular multiplier of claim 15, wherein the calculator circuit comprises:
a segmentable Montgomery multiplier;
a first signal pass circuit configured to transmit first input/output signals between the Montgomery multiplier and the first memory interface in response to the first selection control signals and the second selection control signals; and
a second signal pass circuit configured to transmit second input/output signals between the Montgomery multiplier and the second memory interface in response to the third selection control signals and the fourth selection control signals.

17. The modular multiplier of claim 16, wherein in the first mode, the Montgomery multiplier is configurable to independently and simultaneously perform a first Montgomery multiplication operation for a first operand and a second Montgomery multiplication operation for a second operand to produce respective first operation results and second operation results therefrom, and wherein the first and second operation results are output via respective ones of a combination of the first signal pass circuit and the first memory interface and a combination of the second signal pass circuit and the second memory interface.

18. The modular multiplier of claim 16, wherein in the first mode, the Montgomery multiplier performs one of a first Montgomery multiplication operation for a first operand or a second Montgomery multiplication operation for a second operand and produces a first operation result or a second operation result therefrom, and wherein the first operation result or the second operations result is output via the first signal pass circuit and the first memory interface or the via the second signal pass circuit and the second memory interface.

19. The modular multiplier of claim 16, wherein in the second mode, the second signal pass circuit and the second memory interface operate and the first signal pass circuit and the first memory interface do not operate.

20. The modular multiplier of claim 16, wherein the Montgomery multiplier comprises:
a first multiple modulus generator configured to generate a first multiple modulus signal on the basis of a first accumulation result signal and an upper C bits of a modulus in response to a first generation control signal;
a second multiple modulus generator configured to generate a second multiple modulus signal on the basis of a second accumulation result input signal and a lower C bits of the modulus in response to a second generation control signal;
a first partial product generator configured to generate a first partial product signal on the basis of an upper C bits of a multiplicand in response to a third generation control signal;
a second partial product generator configured to generate a second partial product signal on the basis of a lower C bits of the multiplicand in response to a fourth generation control signal; and
an accumulator configured to accumulate the first and second multiple modulus signals and the first and second partial product signals in response to the shifting signal, the mode control signal and the first through fourth accumulation control signals,
wherein the first and second accumulation result input signals are accumulation results generated during a previous operation performed by the accumulator.

21. The modular multiplier of claim 20, wherein the Montgomery multiplier comprises:
a first modulus recorder configured to output the first generation control signal, the first accumulation control signal, and the first selection control signal on the basis of predetermined lower bits of the first accumulation result input signal, predetermined lower bits of the first partial product signal, predetermined lower bits of the upper C bits of the modulus and the first input accumulation signal, under the control of the first recording control signal; and
a second modulus recorder configured to output one of the second generation control signal and the fifth generation control signal, the second accumulation control signal and one of the second selection control signal and the third selection control signal, on the basis of predetermined lower bits of the second accumulation result input signal, predetermined lower bits of the second partial product signal, and predetermined lower bits of the lower C bits of the modulus and the second input accumulation signal, under the control of the second recording control signal.

22. The modular multiplier of claim 21, wherein the first multiple modulus generator generates the first multiple modulus signal on the basis of the first accumulation result input signal and the upper C bits of the modulus, in response to the fifth generation control signal, and
the second multiple modulus generator generates the second multiple modulus signal on the basis of the second accumulation result input signal and lower C bits of the modulus, in response to the fifth generation control signal.

23. The modular multiplier of claim 21, wherein in the first mode, both the first and second modulus recorders are enabled or one of the first and second modulus recorders is enabled.

24. The modular multiplier of claim 21, wherein the second modulus recorder outputs the fifth generation control signal, the second accumulation control signal and the third selection control signal in the second mode.

25. The modular multiplier of claim 21, wherein the Montgomery multiplier comprises:
a first booth recorder configured to output the third generation control signal, the third accumulation control signal and the fourth selection control signal on the basis of an upper W bits of a multiplier, under the control of the third recording control signal; and
a second booth recorder configured to output one of the fourth generation control signal and the sixth generation control signal or one among the fourth accumulation control signal, a fifth selection control signal and a sixth selection control signal, on the basis of a lower W bits of the multiplier, under the control of the fourth recording control signal.

26. The modular multiplier of claim 25, wherein the first partial product generator generates the first partial product signal on the basis of an upper C bits of a multiplicand in response to the sixth generation control signal, and wherein the second partial product generator generates the second partial product signal on the basis of a lower C bits of the multiplicand in response to the sixth generation control signal.

27. The modular multiplier of claim 25, wherein in the first mode, both the first and second booth recorders are enabled or one of the first and second booth recorders is enabled.

28. The modular multiplier of claim 25, wherein, in the second mode, the second booth recorder outputs the sixth generation control signal, the fourth accumulation control signal and the sixth selection control signal.

29. The modular multiplier of claim 20, wherein the accumulator includes a first sub-accumulator and a second sub-accumulator that are separated or coupled in response to the mode control signal, wherein, when the first and second sub-accumulators are separated, the first and second sub-accumulators independently and simultaneously perform an accumulation operation on the first multiple modulus signal and the first partial product signal and output first and second accumulation result values, respectively, and wherein, when the first and second sub-accumulators are coupled, the first and second sub-accumulators perform an accumulation operation on the first and second multiple modulus signals and the first and second partial product signals and outputs a third accumulation result value.

30. The modular multiplier of claim 29, wherein the Montgomery multiplier further comprises,
a carry propagation adder configured to output first and second added result values in response to the first and second accumulation result values or to output a third added result value in response to the third accumulation result value;
a first added result register configured to store the first added result value; and
a second added result register configured to store one of the second added result value and the third added result value, and
wherein the calculator circuit further comprises a switching circuit configured to connect predetermined ones of output lines of the second signal pass circuit to predetermined ones of output lines of the first signal pass circuit in response to a switching control signal.

31. A cryptography system comprising:
first and second memories configured to store operands for modular multiplication operations;
a modular multiplier configured to read operands from the first and second memories and configurable to perform modular multiplication operations on first bit length operands from the first memory and/or the second memory in a first mode and to perform a modular multiplication operation on second bit length operands from the first and second memories in a second mode;
a host coupled to the modular multiplier and configured to provide a control signal thereto to selectively place the modular multiplier in the first and second modes; and
a memory arbiter coupled to the first and second memories, the modular multiplier and the host and configured to control access to the first and second memories by the host and the modular multiplier responsive to access requests therefrom.

32. The cryptography system of claim 31, wherein the modular multiplier is configurable to perform simultaneous modular multiplication operations on first and second operands from respective ones of the first and second memories in the first mode.

33. The cryptography system of claim 31, wherein the modular multiplier comprises:
a host interface configured to receive a control data signal from the host and to produce an operation information signal in response to the control data signal;
a controller configured to produce a mode control signal and operation control signals in response to the operation information signal; and
a calculator circuit configured to perform modular multiplication operations in the first and second modes in response to the mode control signal and the operation control signals.
